(19) United States
(12) Patent Application Publication
(10) Pub. No.: US 2013/0020957 A1
(43) Pub. Date: Jan. 24, 2013

(54) CIRCUIT ARRANGEMENT AND METHOD FOR OPERATING AT LEAST ONE LED

(71) Applicants: Georg Forster, Muenchen (DE); Ralf Hying, Muenchen (DE); Peter Niedermeier, Muenchen (DE)

(72) Inventors: Georg Forster, Muenchen (DE); Ralf Hying, Muenchen (DE); Peter Niedermeier, Muenchen (DE)

(73) Assignee: OSRAM AG, Muenchen (DE)

(21) Appl. No.: 13/636,346

(22) PCT Filed: Nov. 24, 2010
(86) PCT No.: PCT/EP10/68084

§ 371 Date: Sep. 21, 2012

(30) Foreign Application Priority Data
Mar. 23, 2010 (DE) 102010003136.4

(51) Int. Cl. H05B 37/02

(52) U.S. Cl. 315/210

(57) ABSTRACT

A circuit arrangement for operating an LED may include a switching controller with an output for coupling to the LED; a short-circuiting switch with a control electrode, it being possible for the short-circuiting switch to be connected in parallel with an LED; and a control device with a radiation signal input for supplying a radiation signal and a first output, which is coupled to the control electrode of the short-circuiting switch; wherein the switching controller includes a start/stop input for starting the switch controller, it being possible for the control device to furthermore include a second output which is coupled to the start/stop input of the switching controller, it being possible for the control device to be designed to supply a start/stop signal at its second output for starting and stopping the switching controller depending on the radiation signal.

### TECHNICAL FIELD

The present invention relates to a circuit arrangement for operating at least one LED, having at least one switching controller having an output for coupling to the at least one LED; at least one short-circuiting switch having a control electrode, it being possible for the short-circuiting switch to be connected in parallel to the at least one LED; and having a control device having at least one radiation signal input for supplying a radiation signal and an output which is coupled to the control electrode of the short-circuiting switch. Furthermore, the invention relates to a corresponding method for operating at least one LED using such a switching method.

### PRIOR ART

The problem underlying the present invention relates to the operation of LEDs, in particular power LEDs and their use in imaging units, for example projectors. In the following, the term radiation signal is understood to mean, in particular, radiation in the visible wavelength range and in the infrared wavelength range. Currently, the shortest turn-on time of LEDs is around 4 μs. A fast rise and fall in light output must be guaranteed in order to achieve such short time periods.

Moreover, two procedures are known from the prior art: the desired rapid rise and fall times of the light output can be achieved using a linear controller on a voltage source, it being possible in fact for the current flowing through the LED to be set with high resolution. However, the use of linear controllers is accompanied by a high power loss. A second procedure consists in using a switching controller for triggering the LED, it being possible for the switching controller to be continuously operating and a short-circuiting switch connected in parallel with the LED to be used to short-circuit the LED during the times during which the LED is not intended to emit light. During the times when the LED is short-circuited, the short-circuiting switch accepts the output current of the switching controller. The amplitude of the current is set on the switching controller. This variant also deals with undesirable, high losses.

### REPRESENTATION OF THE INVENTION

The problem of the present invention therefore consists in developing a generic circuit arrangement in such a way that the desired short turn-on times of the LEDs can be guaranteed with lowest possible losses. The problem furthermore consists in providing a corresponding method for operating at least one LED.

These problems are solved by a circuit arrangement having the features of claim 1 and by a method having the features of claim 13.

The present invention is based on the knowledge that, considered over a longer time period, the output current supplied by the switching controller to trigger the LED is in fact only required during comparatively short time intervals. During the majority of the time the output current of the switching controller is unused and converted into power loss. The discrepancy between turn-on time and turn-off time of the LED is especially significant in projectors which use a plurality of LEDs, it being possible for the LEDs to emit radiation at different wavelengths and to be controlled only serially to emit the radiation. In order to reduce the power loss, the invention therefore proposes to operate the switching controller in accordance with the radiation signal, that is to say as the occasion demands. Furthermore, according to the invention, the at least one switching controller therefore includes a start/stop input for starting and stopping the switching controller, it being possible furthermore for the switching device to include a second output which is coupled to the start/stop input of the at least one switching controller, it being possible for the control device to be designed to supply at its second output a start/stop signal for starting and stopping the at least one switching controller, depending on the radiation signal. The result of this is that the cooling measures, for example a blower, are much less likely to fail. Consequently, the energy required for the cooling measures can be reduced. Furthermore, the noise emissions caused by a blower, for example, are also reduced.

Due to this measure, the power loss during the times when the at least one LED does not need to be triggered to emit radiation can be avoided. This time is the equivalent of up to two thirds of the operating time of the circuit arrangement. The extent of the avoided power loss is especially clear considering that the current flowing through the at least one LED can be in the order of 30 A. The use of a switching controller in accordance with the present invention therefore results in appreciably lower losses than the use of a linear controller, even though, nevertheless, turn-on times in the region of less than 3 μs are feasible.

A particularly preferred embodiment of the invention is characterized in that the control device is designed to provide at its second output a start signal for starting the at least one switching controller, which start signal leads by a first specified time period a signal supplied at its first output for non-conducting switching of the short-circuiting switch. This takes into account that approximately two to three switching periods of the switch of the switching controller are necessary in order to produce adequate magnetization of the inductance of the switching regulator. Consequently, due to the switching losses occurring in the power components, an increase in the switching frequency in order to shorten this time period is undesirable. Since the information as to when the LED is to be triggered to emit radiation is available in the control device, which is designed in particular as video electronics, it is therefore possible to start the switching controller in good time in advance, so that at the instant at which the LED is to be turned on, the switching controller is already able to provide the setpoint current. In this connection, set-up times in the order of 5 to 50 μs, preferably 10 μs, are adequate.

Furthermore, the control device can be designed to provide at its second output a stop signal for stopping the at least one switching controller, which stop signal is chronologically related to a signal supplied at its first output for conducting-switching of the short-circuiting switch, in particular which lags this signal by a second specified time period or occurs simultaneously with this signal. In this case, the information present in the control device, as to which instant the LED is triggered to no longer emit radiation, is used to switch off the switching controller. Due to this measure, the switching controller is operated only during the times that are necessary in order to supply a specified setpoint current to the LED during the desired time period. This enables the power loss to be minimized.

Furthermore, the control device preferably includes a third output for coupling to an imaging element, in particular a DLP (digital light processor), it being possible for the control device to be designed to control the imaging element via a signal supplied at its third output. This measure enables the signals supplied at the first, second and third output of the control device to be adjusted with respect to each other.

Furthermore, the control device can have a fourth output which is coupled to the at least one switching controller, it being possible for the control device to be designed via a signal supplied at its fourth output, to control the current intensity of the current to be supplied at the output of the at least one switching controller. As a result, this ensures that the switching controller supplies to the LED a current of the exact intensity that is adjusted for use within the time period in which the LED is triggered to emit radiation. This measure enables in particular aging-related fluctuations in the intensity of the light emitted by the LED to be compensated.

The control device preferably includes a memory device, it being possible for the control device to be designed to store in the memory device a signal correlated to the radiation signal. This buffer storage enables the start signal for starting the switching controller to be supplied chronologically in advance of the signal for non-conducting switching of the short-circuiting switch. Memory devices for this purpose are usually present in projectors anyway in order to ensure stable triggering of the at least one LED according to a current image, whereas the color information of at least one subsequent image is processed in the projector.

If the radiation signal includes a large number of frames, it is preferable if the control device is designed to determine from the radiation signal the start of a respective frame of the large number of frames, it being possible furthermore for the control device to be designed to supply at the second output a start signal for starting the at least one switching controller, which signal leads the signal supplied at its first output for non-conducting switching of the short-circuiting switch by a third specified time period. This measure enables the computing effort in the control device to be reduced. The switching controller is therefore no longer switched on by taking into account the actual, desired turn-on time of the respective LED, but rather is frame-related.

Accordingly, the control device can be designed to determine from the radiation signal the end of a respective frame of the large number of frames, it being possible furthermore for the control device to be designed to supply at the second output a stop signal for stopping the at least one switching controller, which signal lags by a fourth specified time period the signal supplied at its first output for conducting-switching of the short-circuiting switch. Irrespective of whether the LED is to be operated for a shorter or a longer period during the corresponding frame, the switching controller is therefore switched on during the entire frame, so that the setpoint current can be supplied to the LED during the entire frame. Considered over a longer time period, this certainly results in a longer turn-on time of the switching controller than in the case of actual adjustment to the time period in which the LED is to be triggered to emit radiation, but does result in a considerable reduction of the computing effort in the control device. The accompanying rise in the power loss is comparatively small.

A particularly advantageous embodiment is characterized in that it includes at least one first, one second and one third switching controller, it being possible for the output of the first switching controller to be coupled to at least one LED for emitting radiation in a first wavelength range, in particular red, it being possible for the output of the second switching controller to be coupled to at least one LED for emitting radiation in a second wavelength range, in particular green, and it being possible for the output of the third switching controller to be coupled to at least one LED for emitting radiation in a third wavelength range, in particular blue, it being possible for the control device to include at least a first second output that is coupled to the start/stop input of the first switching controller, and to include a second second output that is coupled to the start/stop input of the second switching controller and to include a third second output that is coupled to the start/stop input of the third switching controller. This variant enables a conventional projector to be realized, which includes LEDs for emitting red, green and blue light. Naturally, further LEDs with corresponding triggering can be available, for example LEDs that are designed to emit radiation in the infrared wavelength range.

Alternately, provision can be made for the circuit arrangement to include at least one first, one second and one third switching controller, it being possible for the output of the first switching controller to be coupled to at least one LED for emitting radiation in a first wavelength range, in particular red, it being possible for the output of the second to be coupled to at least one LED for emitting radiation in a second wavelength range, in particular green, and it being possible for the output of the third switching controller to be coupled to at least one LED for emitting radiation in a third wavelength range, in particular blue, it being possible for the second output of the control device to be coupled to the start/stop input of at least the first, the second and the third switching controller. For triggering the switching controller, this variant uses a periodic synchronization signal, frequently available in projectors, for the LED driver in which the first, second and third switching controllers are combined. This reduces the conductors between control device and LED driver and consequently a reduction in costs.

In this connection, the signal supplied at the second output of the control device includes in a serial manner the start/stop signal for at least the first, the second and the third switching controller.

In order to supply the respective start/stop signal to the respective switching controller, a first filter device can be coupled at least between the second output of the control device and the first switching controller, a second filter device can be coupled between the second output of the control device and the second switching controller and a third filter device can be coupled between the second output of the control device and the third switching controller. Naturally, the first to the third filter device can be combined in a common filter device.

Further advantageous embodiments are revealed in the subclaims.

Where applicable, the preferred embodiments and their advantages as represented with reference to an inventive circuit arrangement, correspondingly apply to the inventive method for operating at least one LED.

### BRIEF DESCRIPTION OF THE DRAWING(S)

Exemplifying embodiments of the present invention are now described in detail below with reference to the accompanying drawings, where:

FIG. 1 shows a schematic representation of a first embodiment of an inventive circuit arrangement;

FIG. 2 shows the time characteristic of various signals of the embodiments of an inventive circuit arrangement represented in FIG. 1;

FIG. 3 shows a schematic representation of a second exemplifying embodiment of an inventive circuit arrangement;

FIG. 4 shows the time characteristic of various signals of the embodiment of an inventive circuit arrangement represented in FIG. 3;

FIG. 5 shows a schematic representation of a third exemplifying embodiment of an inventive circuit arrangement; and

FIG. 6 shows the time characteristic of various signals of the embodiment of an inventive circuit arrangement represented in FIG. 5.

### PREFERRED EMBODIMENT OF THE INVENTION

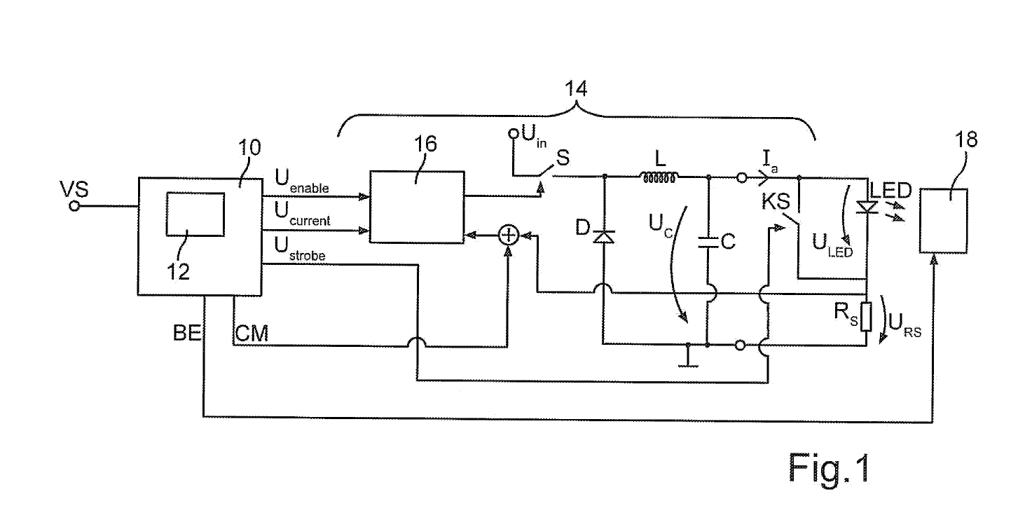

FIG. 1 shows a schematic representation of a first exemplifying embodiment of an inventive circuit arrangement. This includes a control device 10, a video signal VS being supplied to its first input. The control device 10 includes a memory device 12 in which the incoming video information for a current image is buffered, while the video information for a succeeding image is being processed, in particular is conditioned for display on a display device. At the output side, the control device 10 is coupled to a switching controller 14 which is currently designed as a Buck converter. The switching controller 14 includes a switching controller control unit 16 which triggers the electronic switch S of the switching controller 14, that is coupled to a supply voltage Uᵢₙ. The switching controller 14 also includes a diode D as well as an inductance L and a capacitor C. The voltage dropped across the capacitor C is denoted by U_{C}. The parallel circuit of a short-circuiting switch KS and an LED is coupled to the output of the switching controller, it being possible for a shunt resistor R_{S} to be coupled in series with this parallel circuit. The control device 10 provides a U_{enable} signal and a U_{current} signal to the switching controller control unit 16. The control device 10 starts or stops the switching controller 14 by means of the U_{enable} signal. The control device 10 sets the output current Iₐ to be supplied to the LED by the switching controller 14, by means of the U_{current} signal.

Furthermore, the control device 10 triggers the short-circuiting switch KS by means of a U_{strobe} signal. The control device 10 triggers an imaging unit 18, for example a DLP, via a signal BE. In order to provide especially small output currents Iₐ, provision is made for the voltage U_{RS} dropped across the resistor RS to be modified by means of a signal CM supplied by the control device 10. By adding an additional voltage, the voltage drop at the switching controller control unit 16 is seemingly greater than is actually the case. As a result, the switching controller control unit 16 reduces the output current Iₐ by triggering the switch S accordingly.

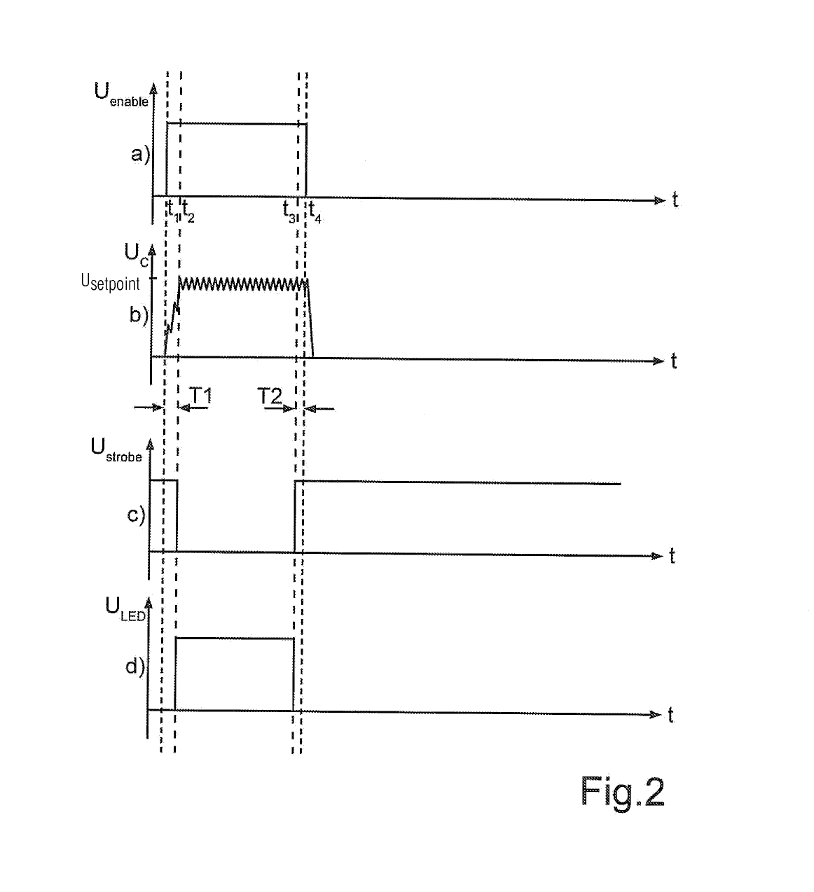

According to the invention, the control device 10 is designed to start and stop the switching controller 14 depending on the radiation signal VS. This is clearly shown with reference to FIG. 2.

FIG. 2 shows the time characteristic of various signals of the exemplifying embodiment of an inventive circuit arrangement represented in FIG. 1. First of all, curve trace a) shows the time characteristic of the U_{enable} signal. The switching controller 14 is therefore switched on at time t₁ and switched off at time t₄. Curve trace b) shows the corresponding waveform of the voltage U_{C} which during operation is dropped across the capacitor C. As can be clearly seen, the switching controller 14 requires the time period T1 to reach the voltage Uₛₑₜₚₒᵢₙₜ, which is needed to supply the required output current Iₐ to the LED. Curve trace c) shows the time characteristic of the trigger signal for the short-circuiting switch KS. This is switched in a non-conducting manner at time t₂ and is again switched in a conducting manner at time t₃. As shown in curve trace d), this results in the waveform of the voltage U_{LED} dropped across the LED during operation. As a comparison between curve traces a) and c) shows, the output signal of the switching controller 14 lags the conducting switching signal of the short-circuiting switch KS by the time period T2. As the comparison between curve traces c) and d) shows, and assuming very short switching times of the short-circuiting switch KS, these run virtually inversely to each other.

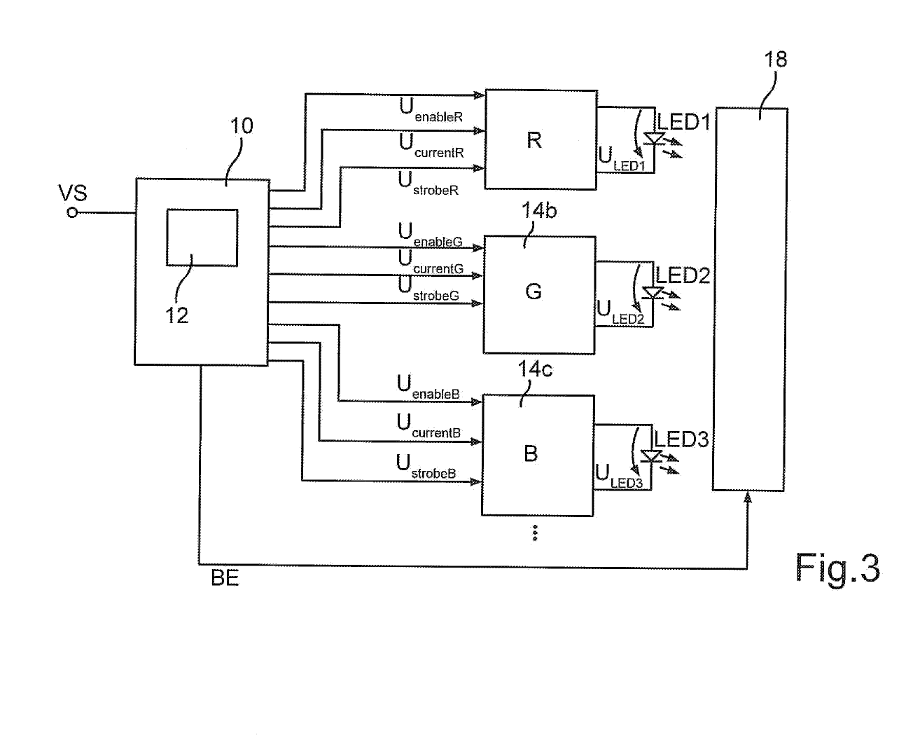

FIG. 3 shows a schematic representation of an exemplifying embodiment of an inventive circuit arrangement which has a plurality of switching controllers 14. The output side of a switching controller 14a is coupled to an LED1 for emitting red light; the output side of a switching controller 14b is coupled to an LED2 for emitting green light and a switching controller 14c is coupled to an LED3 for emitting blue light. In FIG. 3 the respective short-circuiting switches KS include the respective switching controllers 14a to 14c. According to FIG. 1, the control device 10 therefore supplies the U_{enableR}, U_{currentR} and U_{strobeR} signals to the switching controller 14a, the U_{enableG}, U_{currentG} and U_{strobeG} signals to the switching controller 14b and the U_{enableB}, U_{currentB} and U_{strobeB} signals to the switching controller 14C. Furthermore, for the sake of clarity, the CM signals to be supplied if required, are not shown.

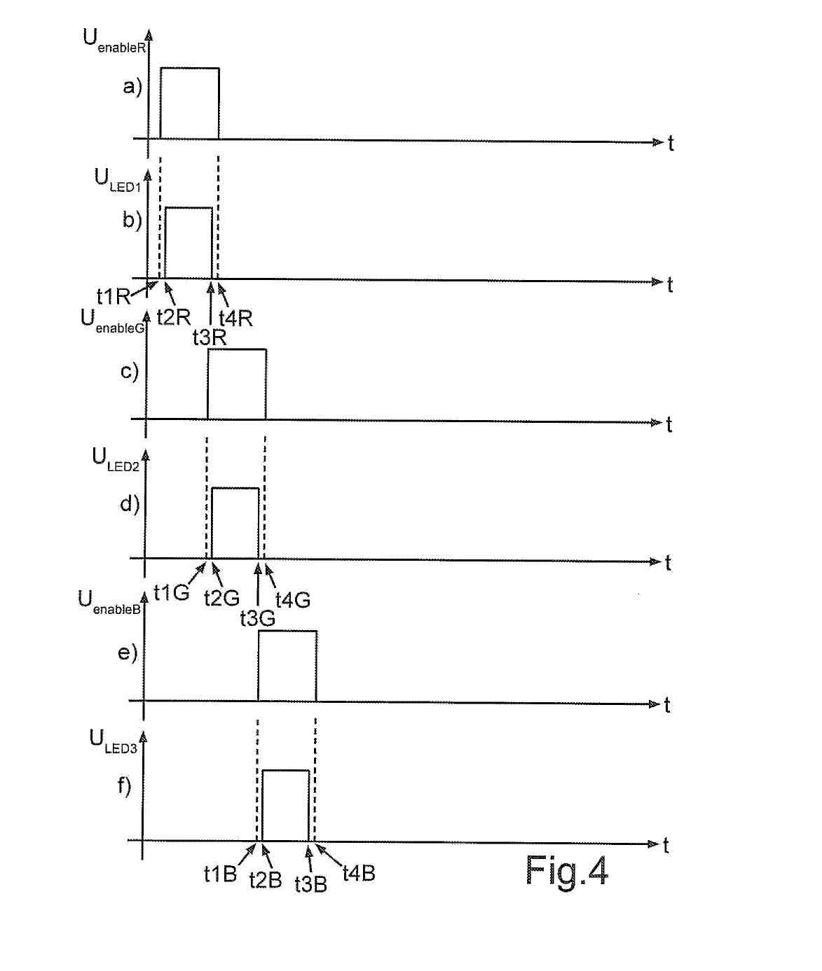

FIG. 4 shows the time characteristics of the U_{enableR}, U_{LED1}, U_{enableG}, U_{LED2}, U_{enableB}, U_{LED3} signals. The curve traces a), c) and e) of FIG. 4 correspond to the curve trace a) of FIG. 2. The curve traces b), d) and f) of FIG. 4 correspond to the curve trace d) of FIG. 2. As already mentioned, the respective signals U_{strobeR}, U_{strobeG}, U_{strobeB} run inversely to the signals U_{LED1}, U_{LED2} and U_{LED3}, respectively.

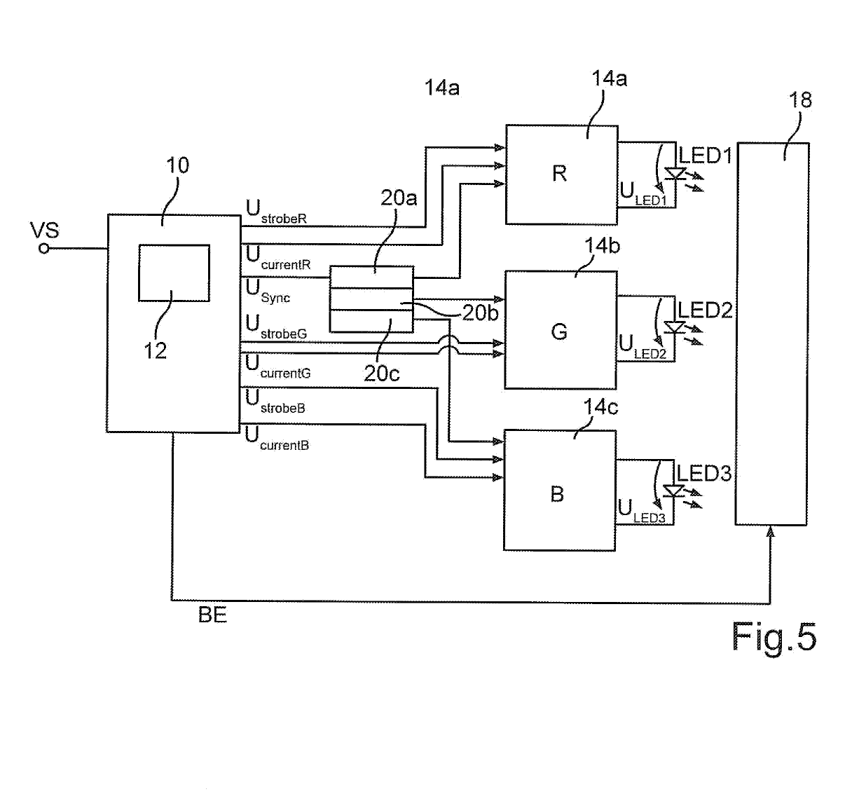

The embodiment of an inventive circuit arrangement shown in FIG. 5 corresponds predominantly to the exemplifying embodiment shown in FIG. 3, so that only the differences will be dealt with. In the exemplifying embodiment shown in FIG. 5, a signal U_{sync} supplied by the control device 10 is used to switch the switching controllers 14a, 14b, 14c on and off. The U_{sync} signal is a periodic synchronization signal from which the current information is evaluated regarding in which frame, if applicable, LED1 is to be triggered to emit radiation, in which frame, if applicable, LED2 is to be triggered to emit radiation, or in which frame LD3 is to be triggered to emit radiation. Whereas in the embodiment shown in FIG. 3 the control device 10 is designed to determine by computation the times t₁, t₂, t₃, t₄, from image to image, in the embodiment of the switching controller shown in FIG. 5, irrespective of the actual turn-on time, the corresponding LED is switched on promptly before a corresponding frame and switched off immediately after a frame. This does offer the advantage that the corresponding switching controller 14a to 14c is switched on if necessary, although in the corresponding image no spectral components of the associated LED are needed; as a result, however, the computing effort needed in the control device 10 to determine the times t₁ to t₄ of FIG. 2 can be omitted. Filter devices 20a, 20b, 20c are provided to make the serial frame information present in the U_{sync} signal available for the respective switching controller 14a to 14c. The filter devices 20a to 20c are therefore designed to use the frame information for switching on the respective switching controller 14a to 14c. On the other hand, the U_{strobeR}, U_{strobeG} and U_{strobeB} signals are delayed for a sufficiently long period so that at the time at which the corresponding short-circuiting switch is actuated in a non-conducting manner, the switching controllers 14a to 14c are already able to supply the required output current.

In one embodiment—not shown—the principle of the evaluation of the frame information for reducing the computing effort in the control device 10, as described with reference to FIG. 5, is also employed in one embodiment having only one switching controller, as shown in FIG. 1.

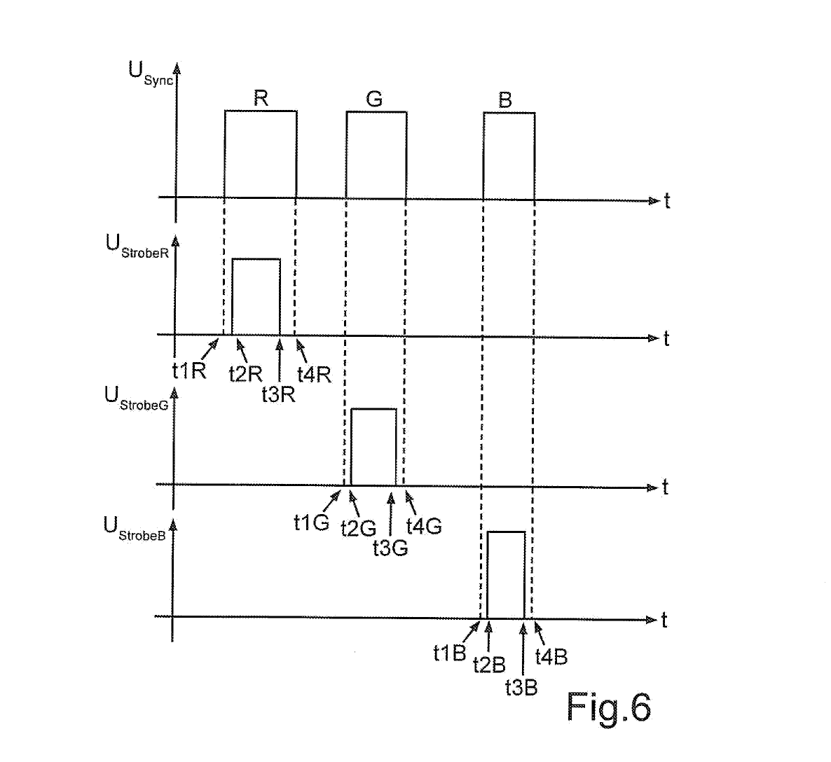

FIG. 6 shows the time characteristics of the U_{sync}, U_{strobeR}, U_{strobeG} and U_{strobeB} signals for the exemplifying embodiment of FIG. 5. As can be clearly seen, the U_{sync} signal includes in serial fashion the frame information for the red light emitting LED1, the green light emitting LED2 and the blue light emitting LED3. Compared to the illustration of FIG. 4, the times t_{4R}, t_{4G} and t_{4B} are fixed in FIG. 6, whereas in FIG. 4 they are only fixed at the corresponding times t_{3R}, t_{3G} and t_{3B}. The synchronization information for the generation of the U_{sync} signal can be obtained from the characteristic of the U_{strobeR}, U_{strobeG} and U_{strobeB} signal.

1. A circuit arrangement for operating at least one light emitting diode, comprising
at least one switching controller with an output for coupling to the at least one light emitting diode;
at least one short-circuiting switch with a control electrode, it being possible for the short-circuiting switch to be connected in parallel with at least one light emitting diode; and
a control device with at least one radiation signal input for supplying a radiation signal and a first output, which is coupled to the control electrode of the short-circuiting switch;
wherein the at least one switching controller furthermore includes a start/stop input for starting the switch controller, it being possible for the control device to furthermore include a second output which is coupled to the start/stop input of the at least one switching controller, it being possible for the control device to be designed to supply a start/stop signal at its second output for starting and stopping the at least one switching controller depending on the radiation signal.

2. The circuit arrangement as claimed in claim 1,
wherein the control device is designed to provide at its second output a start signal for starting the at least one switching controller, which signal leads a signal at its first output for non-conducting switching of the short-circuiting switch, by a first specified time period.

3. The circuit arrangement as claimed in claim 2,
wherein the control device is furthermore designed to provide at its second output a stop signal for stopping the at least one switching controller, which signal is chronologically related to a signal supplied at its first output for conducting switching of the short-circuiting switch.

4. The circuit arrangement as claimed in claim 1,
wherein the control device furthermore has a third output for coupling to an imaging element, it being possible for the control device to be designed to control the imaging element via a signal supplied at its third output.

5. The circuit arrangement as claimed in claim 4,
wherein the control device furthermore has a fourth output that is coupled to the at least one switching controller, it being possible for the control device to be designed to control the current intensity of the current to be supplied at the output of the at least one switching controller, via a signal supplied at the fourth output of said control device.

6. The circuit arrangement as claimed in claim 1,
wherein the control device includes a memory device, it being possible for the control device to be designed to store a signal correlated to the radiation signal, in the memory device.

7. The circuit arrangement as claimed in claim 1,
wherein the radiation signal includes a large number of frames, it being possible for the control device to be designed to determine from the radiation signal the start of a respective frame of the large number of frames, it being possible furthermore for the control device to be designed to supply at the second output a start signal for starting the at least one switching controller, which signal leads the signal supplied at its first output for non-conducting switching of the short-circuiting switch, by a third specified time period.

8. The circuit arrangement as claimed in claim 7,
wherein the control device is designed to determine from the radiation signal the end of a respective frame of the large number of frames, it being possible for the control device furthermore to be designed to supply at the second output a stop signal for stopping the at least one switching controller, which signal lags the signal supplied at its first output for conducting switching of the short-circuiting switch, by a fourth specified time period.

9. The circuit arrangement as claimed in claim 1,
wherein it includes at least one first, one second and one third switching controller, it being possible for the output of the first switching controller to be coupled to at least one light emitting diode for emitting radiation in a first wavelength range,
it being possible for the output of the second switching controller to be coupled to at least one light emitting diode for emitting radiation in a second wavelength range, and
it being possible for the output of the third switching controller to be coupled to at least one light emitting diode for emitting radiation in a third wavelength range, in particular blue,
it being possible for the control device to include at least one first, second output that is coupled to the start/stop input of the first switching controller, as well as a second, second output that is coupled to the start/stop input of the second switching controller, and a third, second output that is coupled to the start/stop input of the third switching controller.

10. The circuit arrangement as claimed in claim 1,
wherein it includes at least one firs, one second and one third switching controller, it being possible for the output of the first switching controller to be coupled to at least one light emitting diode for emitting radiation in a first wavelength range,
it being possible for the output of the second switching controller to be coupled to at least one light emitting diode for emitting radiation in a second wavelength range, and
it being possible for the output of the third switching controller to be coupled to at least one light emitting diode for emitting radiation in a third wavelength range,
it being possible for the second output of the control device to be coupled to the start/stop input of at least the first, the second and the third switching controller.

11. The circuit arrangement as claimed in claim 10,
wherein the signal supplied at the second output of the control device includes in a serial manner the start/stop signal for at least the first, the second and the third switching controller.

12. The circuit arrangement as claimed in claim 10,
wherein a first filter device is coupled at least between the second output of the control device and the first switching controller, a second filter device is coupled between the second output of the control device and the second switching controller and a third filter device is coupled between the second output of the control device and the third switching controller.

13. A method for operating at least one light emitting diode using a circuit arrangement,
the circuit arrangement comprising:
at least one switching controller comprising an output for coupling to the at least one light emitting diode;
at least one short-circuiting switch comprising a control electrode, it being possible for the short-circuiting switch to be connected in parallel with the at least one light emitting diode; and
a control device having at least one radiation signal input for supplying a radiation signal, and a first output that is coupled to the control electrode of the short-circuiting switch;
the method comprising:
starting and stopping the switching controller by means of the control device, depending on the radiation signal.

14. The circuit arrangement as claimed in claim 3,
wherein the signal one of lags this signal by a second specified time period and occurs simultaneously with said signal.

15. The circuit arrangement as claimed in claim 4,
wherein the imaging element is a digital light processor.

16. The circuit arrangement as claimed in claim 9,
wherein the first wavelength range is a red color wavelength range;
wherein the second wavelength range is a green color wavelength range; and
wherein the third wavelength range is a blue color wavelength range.

17. The circuit arrangement as claimed in claim 10,
wherein the first wavelength range is a red color wavelength range;
wherein the second wavelength range is a green color wavelength range; and
wherein the third wavelength range is a blue color wavelength range.
